(19) United States
(12) Patent Application Publication
(10) Pub. No.: US 2024/0099929 A1
(43) Pub. Date: Mar. 28, 2024

(54) WRIGGLE MASSAGER

(71) Applicant: Shenzhen Siling E-Commerce Co., Ltd., Shenzhen (CN)

(72) Inventor: CHAO QIAN, Shenzhen (CN)

(21) Appl. No.: 17/962,542

(22) Filed: Oct. 9, 2022

(30) Foreign Application Priority Data
Sep. 23, 2022 (CN) 202222536173.8

(51) Int. Cl. A61H 19/00; A61H 23/02

(52) U.S. Cl. CPC A61H 19/32; A61H 23/0254; A61H 2201/1215; A61H 2201/14; A61H 2201/1472; A61H 2201/1635; A61H 2201/1661; A61H 2201/1671

(57) ABSTRACT

A wriggle massager includes a soft rubber sleeve, and a massaging structure received in, the soft rubber sleeve and including a bracket, a driving member installed on the bracket, a snakelike transmission shaft and a bulge member, the driving member connected with the snakelike transmission shaft to control rotation of the snakelike transmission shaft. The snakelike transmission shaft includes at least one curve portion and the bulge member includes a transmission channel so that the snakelike transmission shaft is inserted into the transmission channel through one end of the transmission channel. A rotation contour of the at least one curve portion exceeds a radial contour of the transmission channel, so that the snakelike transmission shaft rotates to drive the bulge member to wriggle. The present disclosure provides that the snakelike transmission shaft rotates to drive the bulge member to wriggle for providing a new massage mode and improving users' experience.

### BACKGROUND

### 1. Technical Field

The present disclosure generally relates to the field of medical devices, and especially relates to a wriggle massager.

### 2. Description of Related Art

A conventional massager is an adult product and an internal massaging structure of a conventional female massager usually moves in a straight line or in the form of vibration. Therefore, it is necessary to provide a wriggle massager with a new movement mode to improve users' experience.

### SUMMARY

The technical problems to be solved: in view of the shortcomings of the related art, the present disclosure provides an improved wriggle massager which can massage a person via a wriggle massaging way to improve users' experience.

The technical solution adopted for solving technical problems of the present disclosure is: a wriggle massager according to an embodiment of the present disclosure includes a soft rubber sleeve and a massaging structure received in the soft rubber sleeve. The massaging structure includes a bracket, a driving member installed on the bracket, a snakelike transmission shaft and a bulge member; the driving member connected with the snakelike transmission shaft to control, rotation of the snakelike transmission shaft; the snakelike transmission shaft including at least one curve portion and the bulge member including a transmission channel so that the snakelike transmission shaft is inserted into the transmission channel from an end of the transmission channel; a rotation contour of the at least one curve portion exceeds a radial contour of the transmission channel, so that the snakelike transmission shaft rotates to drive the bulge member to wriggle.

Wherein the bracket includes a handle portion, a base opposite to the handle portion and two groups of positioning rods arranged between the handle portion and the base, the snakelike transmission shaft passing through the transmission channel, and two opposite ends of the snakelike transmission shaft respectively connected with the handle portion and the base; and the bulge member arranged between the handle portion and the base, two positioning channels formed inside the bulge member, the two groups of positioning rods respectively inserted into the two positioning channels correspondingly, and a movable space arranged between the positioning channel and the positioning rod that has been inserted into the positioning channel, so that the bulge member can wriggle in the movable space.

Wherein the bulge member includes a plurality of bulging discs coaxially superimposed thereof.

Wherein each of the plurality of bulging discs includes a transmission hole formed at a middle thereof and two positioning holes formed thereof, and the plurality of transmission holes is correspondingly superposed to form the transmission channel; the two positioning holes correspondingly superposed to respectively form the two positioning channels.

Wherein the transmission hole is a transverse-circular-square structure, the positioning hole is a longitudinal-circular-square structure, and the two positioning holes of the bulging disc are symmetrically arranged relative to the transmission hole of the same bulging disc.

Wherein the wriggle massager further includes a spring installed at a tail end of the bulge member, two ends of the spring respectively abut against the tail end of the bulge member and the base of the bracket.

Wherein the wriggle massager further includes a motor mounted on a side of the base away from the bulge member.

Wherein the handle portion includes a first half housing, a second half housing engaged with the first half housing, and a cover installed on the second half housing; a driving chamber formed between the first half housing and the second half housing, the driving member installed in the driving chamber; a receiving room arranged between the cover and the second half housing; an output shaft of the driving member extending into the receiving room, and a head of the snakelike transmission shaft connected with the output shaft in the receiving room.

Wherein the bulging disc is circular.

Wherein the snakelike transmission shaft is coaxial with the transmission channel, and a rotation radius of the snakelike transmission shaft is at least greater than radiuses of some positions of the transmission channel.

The present disclosure provides the advantages as below: the wriggle massager of the present disclosure provides that the snakelike transmission shaft drives the bulge member to massage a person via a wriggle massaging way, which is conducive to improving users' experience.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. The same reference numerals in the accompanying drawings indicate the same or similar components or parts, one of ordinary skill in the related art should understand that these drawings are not necessarily drawn to scale.

FIG. 1 is a schematic view of a wriggle massager in accordance with an embodiment of the present disclosure.

FIG. 2 is a schematic view of a massaging structure of the wriggle massager of FIG. 1.

FIG. 3 is an exploded, schematic view of the massaging structure of the wriggle massager of FIG. 1.

FIG. 4 is a schematic view of a bulge member and a snakelike transmission shaft of the wriggle massager of FIG. 1.

FIG. 5 is a schematic view of the snakelike transmission shaft, a driving member and a base of the wriggle massager of FIG. 1.

FIG. 6 is a schematic view of a bulging disc of the wriggle massager of FIG. 1.

FIG. 7 is a schematic view of a wriggle principle of the bulge member of the wriggle massager of FIG. 1.

The element labels according to the embodiment of the present disclosure shown as below
1 wriggle massager, 100 massaging structure, 101 soft rubber sleeve, 2 bracket, 200 handle portion, 201 base, 202 first half housing, 203 second half housing, 204 cover, 205 driving chamber, 206 receiving room, 3 bulge member, 300 bulging disc, 300a first position, 300b second position, 301 transmission channel, 302 positioning channel, 3020 movable space, 303 transmission hole, 304 positioning hole, 305 radial contour, 4 driving member, 400 output shaft, 5 snakelike transmission shaft, 500 curve portion, 501 head, 502 tail, 503 rotation contour, 503a portion, 6 positioning, rod, 7 spring, 8 motor.

### DETAILED DESCRIPTION

In order to more clearly understand the technical solution hereinafter in embodiments of the present disclosure, reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples.

According to the described embodiment of the present disclosure, all other embodiments obtained by one of ordinary skill in the related art without the need for a creative labor are within the protection scope of the present disclosure. Unless defined otherwise, the technical terms or scientific terms used for the present disclosure shall be a general meaning commonly understood by those having ordinary skill in the related art to which the present disclosure is applied.

In the description of the present disclosure, it needs to be understood that the terms mentioned below: the terms such as “first” and “second” shown in the specification are only used to describe, but not indicated that the elements of the present disclosure is important or represented the amount of the elements. That is, the features limited by the terms of “first” and “second” may explicitly or implicitly include one or more features. Similar, in the description of the present disclosure, the meaning of the tem′ “one”, and “the” don't indicate a quantitative limit, but rather not less than two unless it is specifically illustrated. Furthermore, the terms such as “include”, “including”, “comprising” and “comprise” and the like means that elements or items in front of such term is intended to cover the elements or objects appeared the list behind the term and its equivalent, without excluding other elements or items. In the description of the present disclosure, except where specifically otherwise illustrated or limited, the tell is “install”, “connect”, “link” and “fix” used herein should be understood in a broad perceive. Such as, the meaning may be tight connection, removable connection, or integrated connection. The meaning may also be mechanical connection, electrical connection, direct connection or indirect connection through intermediaries, or internal connection within two elements. The meaning of the terms used herein may be understood by one of ordinary skill in the related art according to specific conditions of the present disclosure. In addition, the terms such as “upper”, “below”, “left”, and “right”, etc, are shown in the specification of the present disclosure. The indicated orientation or position of the terms shown in the detailed description is based on the orientation or position shown in the figures of the accompanying drawings of the present disclosure, which is only to easily simplify the description of the present disclosure, but not indicated that the devices or elements of the present disclosure should have a particular orientation or should be designed and operated in a particular orientation. So the terms illustrated in the detail description are not by way of the limitation, of the present disclosure.

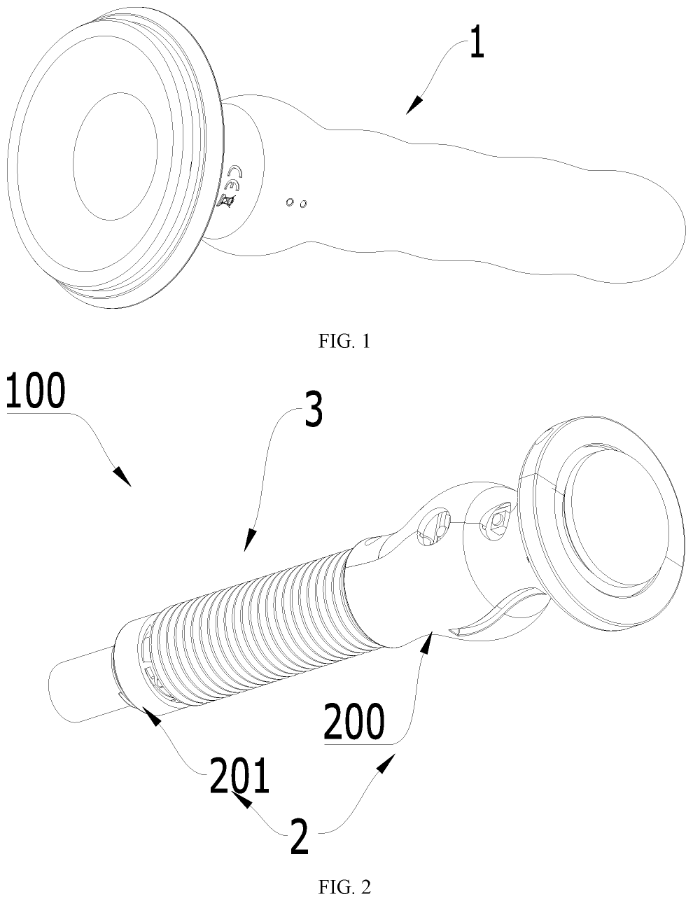

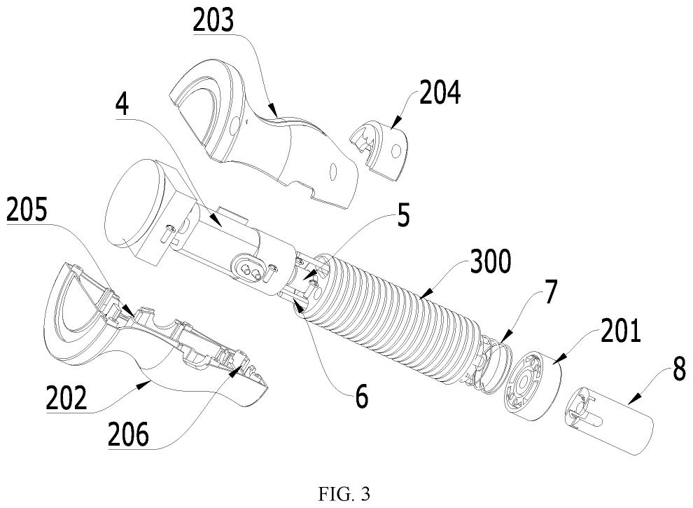

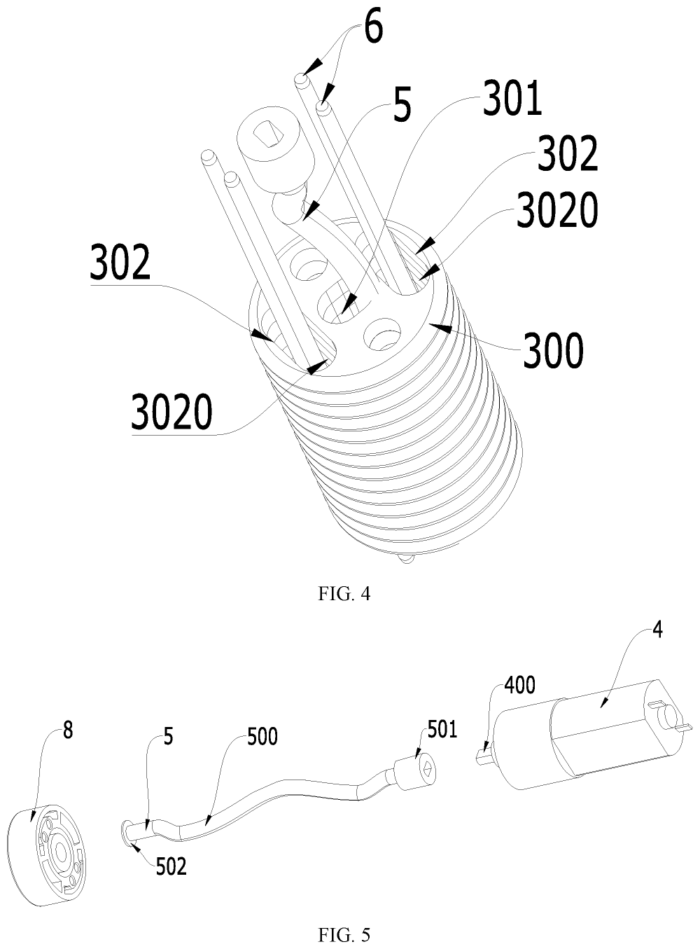

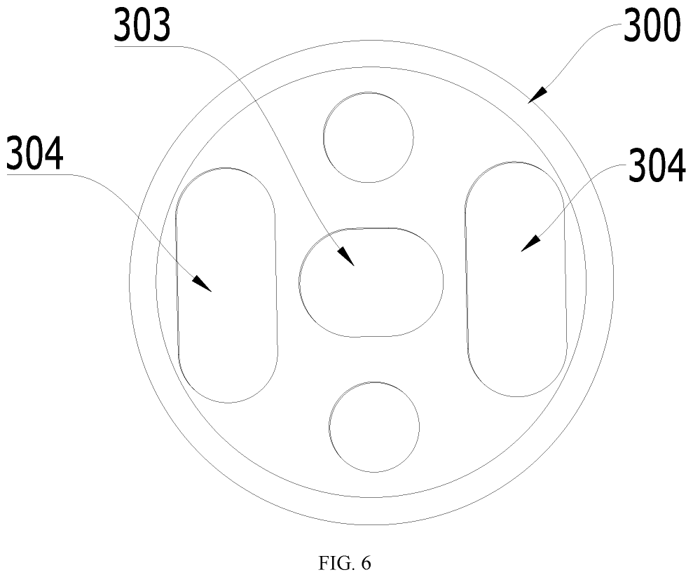

Referring to FIGS. 1-7, a wriggle massager according to an embodiment of the present disclosure includes a soft rubber sleeve 101 and a massaging structure 100 received in the soft rubber sleeve 101. The massaging structure 100 includes a bracket 2, a driving member 4 installed on the bracket 2, a snakelike transmission shaft 5 and a bulge member 3; the driving member 4 is connected with the snakelike transmission shaft 5 to control rotation of the snakelike transmission shaft 5; the snakelike transmission shaft 5 including at least one curve portion 500 and the bulge member 3 including a transmission channel 301 so that the snakelike transmission shaft 5 is inserted into the transmission channel 301 from an end of the transmission channel 301; a rotation contour 503 of the at least one curve portion 500 exceeds a radial contour 305 of the transmission channel 301, so that the snakelike transmission shaft 5 rotates to drive the bulge member 3 to wriggle.

The driving member 4 can be fixed on the bracket 2 by screws and generally includes a reduction gearbox motor. The snakelike transmission shaft 5 is connected with the reduction gearbox motor, and the bulge member 3 is installed on the bracket 2. When the bulge member 3 is stressed by a force that has been applied by the snakelike transmission shaft 5, the bulge member 3 can be wriggled. The driving member 4 provides a driving force for the snakelike transmission shaft 5 to control rotation of the snakelike transmission shaft 5. The snakelike transmission shaft 5 has the curve portion 500, preferably a plurality of curve portions 500. After the plurality of curve portions 500 is connected together, the snakelike transmission shaft 5 is roughly in a spiral curve structure. In this way, when the snakelike transmission shaft 5 rotates, the rotation contour 503 of the curve section 500 exceeds the radial contour 305 of the transmission channel 301, and generates a radial outward force on an inner wall of the transmission channel 301, causing the bulge member 3 to wriggle. Therefore, with the continuous rotation of the curve section 500, various parts of the bulge member 3 will be displaced and bulged, so that the bulge member 3 continuously wriggle as a whole.

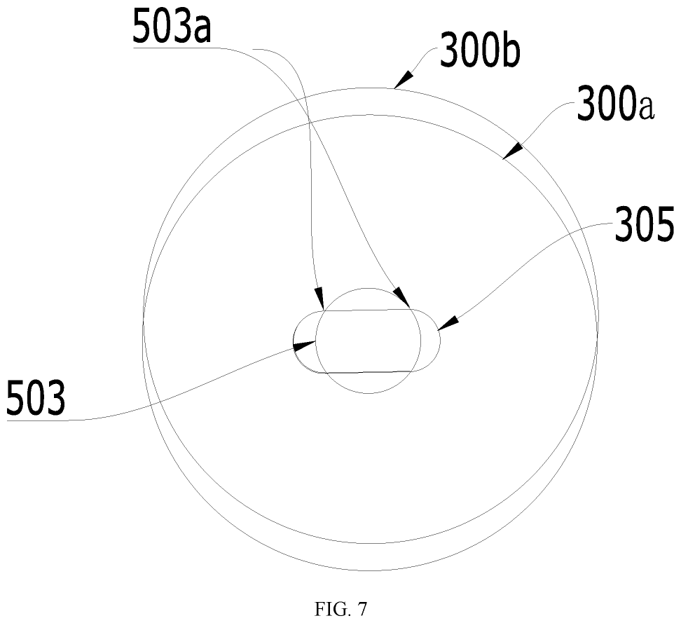

In some embodiments of the present disclosure, the snakelike transmission shaft 5 is coaxial with the transmission channel 301, and a rotation radius of the snakelike transmission shaft 5 is at least greater than radiuses of some positions of the transmission channel 301. Referring to FIG. 7, a section schematic view of the bulge member 3 and the snakelike transmission shaft 5 is shown. The rotation contour 503 of the snakelike transmission shaft 5 is circular, and the rotation contour 503 can rotate within the transmission channel 301. At least in a portion 503a, the rotation radius of the snakelike transmission shaft 5 is greater than the radius of the transmission channel 301, that is, in the portion 503a, a radial dimension of the rotation contour 503 is larger than that of the transmission channel 301, so that the portion 503a of the rotation contour 503 generates a radial outward force that is applied on the bulge member 3. With reference to a direction as shown in FIG. 7, when the bulge member 3 is pushed by the portion 503a, the bulge member 3 will shift from a first position 300a to a second position 300b. It can be seen that when the snakelike transmission shaft 5 rotates, the bulge member 3 as a whole will be subjected to the radial force applied by the curve section 500 of the snakelike transmission shaft 5, so that each position of the bulge member 3 will be displaced and bulged, thereby causing the wriggle massager to perform a wiggling effect on a person.

In some embodiments of the present disclosure, the bracket 2 includes a handle portion 200, a base 201 opposite to the handle portion 200 and two groups of positioning rods 6 arranged between the handle portion 200 and the base 201, the snakelike transmission shaft 5 passing through the transmission channel 301, and two opposite ends of the snakelike transmission shaft 5 respectively connected with the handle portion 200 and the base 201; and the bulge member 3 arranged between the handle portion 201 and the base 200, two positioning channels 302 formed inside the bulge member 3, the two groups of positioning rods 6 respectively inserted into the two positioning channels 302 correspondingly, and a movable space 3020 arranged between the positioning channel 302 and the positioning rod 6 that has been inserted into the positioning channel 302, so that the bulge member 3 can wriggle in the movable space 3020.

The two groups of positioning rods 6 are set to solve a problem of preventing the bulge member 3 from rotating along the snakelike transmission shaft 5. The two groups of positioning rods 6 pass through the positioning channel 302 of the bulge member 3 to interfere with the rotation of the bulge member 3. At the same time, in order to prevent the bulge member 3 from being completely fixed and affecting its wriggling by the force of the snakelike transmission shaft 5, it is necessary to leave the corresponding movable space 3020 between the positioning rod 6 and the positioning channel 302.

The bulge member 3 can be a flexible tube, but because it is an integral structure, it has a poor wriggling effect under the radial force of the snakelike transmission shaft 5. Therefore, in an embodiment of the present disclosure, it is preferred to set a plurality of bulging discs 300 on the bulge member 3, so that the plurality of bulging discs 300 are coaxially superposed to foul the bulge member 3 with a certain length, and the plurality of bulging discs 300 are independent from each other, which makes an action of the bulge member 3 more flexible after the bulge member 3 is pushed by the snakelike transmission shaft 5, so that an overall wriggling effect of the bulge member 3 is better.

In some embodiments of the present disclosure, the bulging disc 300 is preferably set as a circular configuration with none prominent angularities, which can be, more comfortable to massage persons.

In some embodiments of the present disclosure, each of the plurality of bulging discs 300 includes a transmission hole 303 faulted at a middle thereof and two positioning holes 304 formed thereon, and the plurality of transmission holes 303 is correspondingly superposed to form the transmission channel 301; the two positioning holes 304 correspondingly superposed to respectively form the two positioning channels 302. The plurality of transmission holes 303 in the middle of the plurality of bulging discs 300 have the same structure and are superposed correspondingly, thereby for sling the transmission channel 301 that axially passes through the bulge member 3. The two positioning holes 304 of each bulging disc 300 have the same structure as the two positioning holes 304 of other bulging discs 300, and the positioning holes 304 of the plurality of bulging discs 300 are superposed correspondingly, thereby forming the corresponding two positioning channels 302 that axially pass through the bulge member 3.

Preferably, the transmission hole 303 is a transverse-circular-square structure (a diameter that is long in a transverse direction and short in a longitudinal direction), the positioning hole 304 is a longitudinal-circular-square structure (the diameter is long in the longitudinal direction and short in the transverse direction), and the two positioning holes 304 of the bulging disc 300 are symmetrically arranged relative to the transmission hole 303 of the same bulging disc 300. The transmission hole 303 is the transverse-circular-square structure, in this way, when the snakelike transmission shaft 5 rotates, a lateral offset distance of the bulge member 3 is smaller than a longitudinal offset distance of the bulge member 3, in this way, the positioning hole 304 is set as the longitudinal-circular-square structure, which just adaptive thereof.

In some embodiments of the present disclosure, the wriggle massager further includes a spring 7 installed at a tail end of the bulge member 3, two ends of the spring 7 respectively abut against the tail end of the bulge member 3 and the base 201 of the bracket 2. The plurality of superimposed bulging discs 300 is closely superimposed together, and a friction force is formed between each two adjacent bulging discs 300, which will affect an offset movement of the bulging discs 300. Therefore, the spring 7 is arranged at the tail end of the bulge member 3 to provide a certain elastic buffer space for the plurality of superimposed bulging discs 300 along an axial direction of the bulge member 3, which is conducive to the offset movement of the plurality of bulging discs 300 and reduce noises. At the same time, the spring 7 can elastically squeeze the plurality of bulging discs 300 to avoid that looseness is occurred thereamong to influence the overall wriggling effect of the wriggle massager.

In some embodiments of the present disclosure, the wriggle massager further includes a motor 8 mounted on a side of the base 201 away from the bulge member 3. When the motor 8 is turned on, vibration of the motor 8 is transmitted to the wriggle massager 1 through the base 201, so that a vibration massage is added on the basis of the wriggling massage of the bulge member 3 to enrich the users' experience.

In some embodiments of the present disclosure, the handle portion 200 includes a first half housing 202, a second half housing 203 engaged with the first half housing 202, and a cover 204 installed on the second half housing 203; a driving chamber 205 formed between the first half housing 202 and the second half housing 203, the driving member 4 installed in the driving chamber 205; a receiving room 206 for lied between the cover 4 and the second half housing 204; an output shaft 400 of the driving member 4 extending into the receiving room 206, and a head 501 of the snakelike transmission shaft 5 connected with the output shaft 400 in the receiving room 206.

A control main board of the drive member 4 and the motor 8 can be installed in the driving chamber 205, and can be controlled by pressing keys. The output shaft 400 of the drive member 4 can be a flat shaft and extends from the driving chamber 205 to the receiving room 206; the head 501 of the snakelike transmission shaft 5 includes a corresponding flat hole. A radial size of the head 501 is greater, and a cavity of the receiving room 206 is correspondingly smaller, so that the head 501 of the snakelike transmission shaft 5 can be rotated and clamped in the receiving room 206 to assemble with the output shaft 400 of the driving member 4. Similarly, the base 201 can include a cavity, as an opening of the cavity is smaller, the radial size of a tail 502 of the snakelike transmission shaft 5 is greater, so that the tail 502 can be rotatably clamped in the cavity.

When the wriggle massager is used, the massaging structure 100 of the wriggle massager, especially the bulge member 3, is put into the body of a person, and the soft rubber sleeve 101 is used to ensure a comfortable touch with the body. The strip-shaped bulge member 3 twists and massages in the body for generating stimulation, and effectively improving the users' experience.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A wriggle massager comprising:
a soft rubber sleeve;
a massaging structure received in the soft rubber sleeve and comprising:
a bracket, a driving member installed on the bracket, a snakelike transmission shaft and a bulge member; and wherein
the driving member is connected with the snakelike transmission shaft to control rotation of the snakelike transmission shaft; the snakelike transmission shaft comprising at least one curve portion and the bulge member comprising a transmission channel so that the snakelike transmission shaft is inserted into the transmission channel from an end of the transmission channel; and wherein a rotation contour of the at least one curve portion exceeds a radial contour of the transmission channel, so that the snakelike transmission shaft rotates to drive the bulge member to wriggle.

2. The wriggle massager as claimed in claim 1, wherein the bracket comprises a handle portion, a base opposite to the handle portion and two groups of positioning rods arranged between the handle portion and the base, the snakelike transmission shaft passing through the transmission channel, and two opposite ends of the snakelike transmission shaft respectively connected with the handle portion and the base; and
the bulge member arranged between the handle portion and the base, two positioning channels formed inside the bulge member, the two groups of positioning rods respectively inserted into the two positioning channels correspondingly, and a movable space arranged between the positioning channel and the positioning rod that has been inserted into the positioning channel, so that the bulge member can wriggle in the movable space.

3. The wriggle massager as claimed in claim 2, wherein the bulge member comprises a plurality of bulging discs coaxially superimposed thereof.

4. The wriggle massager as claimed in claim 3, wherein each of the plurality of bulging discs comprises a transmission hole formed at a middle thereof and two positioning holes formed thereon, and the plurality of transmission holes is correspondingly superposed to form the transmission channel; the two positioning holes correspondingly superposed to respectively form the two positioning channels.

5. The wriggle massager as claimed in claim 4, wherein the transmission hole is a transverse-circular-square structure, the positioning hole is a longitudinal-circular-square structure, and the two positioning holes of the bulging disc are symmetrically arranged relative to the transmission hole of the same bulging disc.

6. The wriggle massager as claimed in claim 3, wherein the wriggle massager further comprises a spring installed at a tail end of the bulge member, two ends of the spring respectively abut against the tail end of the bulge member and the base of the bracket.

7. The wriggle massager as claimed in claim 6, wherein the wriggle massager further comprises a motor mounted on a side of the base away from the bulge member.

8. The wriggle massager as claimed in claim 2, wherein the handle portion comprises a first half housing, a second half housing engaged with the first half housing, and a cover installed on the second half housing; a driving chamber foliated between the first half housing and the second half housing, the driving member installed in the driving chamber; a receiving room formed between the cover and the second half housing; an output, shaft of the driving member extending into the receiving room, and a head of the snakelike transmission shaft connected with the output shaft in the receiving room.

9. The wriggle massager as claimed in claim 2, wherein the bulging disc is circular.

10. The wriggle massager as claimed in claim 1, wherein the snakelike transmission shaft is coaxial with the transmission channel, and a rotation radius of the snakelike transmission shaft is at least greater than radiuses of some positions of the transmission channel.
